(19) United States
(12) Patent Application Publication
(10) Pub. No.: US 2023/0078058 A1
(43) Pub. Date: Mar. 16, 2023

(54) COMPUTING SYSTEMS EMPLOYING A SECURE BOOT PROCESSING SYSTEM THAT DISALLOWS INBOUND ACCESS WHEN PERFORMING IMMUTABLE BOOT-UP TASKS FOR ENHANCED SECURITY, AND RELATED METHODS

(71) Applicant: Ampere Computing LLC, Santa Clara, CA (US)

(72) Inventors: Phil Mitchell, San Jose, CA (US); Harb Ali Abdulhamid, Raleigh, NC (US); Kha Hong Nguyen, San Jose, CA (US)

(21) Appl. No.: 17/472,103

(22) Filed: Sep. 10, 2021

(51) Int. Cl. G06F 21/57; G06F 21/55; G06F 21/54; G06F 21/85

(52) U.S. Cl. CPC G06F 21/575; G06F 21/554; G06F 21/54; G06F 21/85

(57) ABSTRACT

Computing systems employing a secure boot processing system that disallows in-bound access when performing immutable boot-up tasks for enhanced security, and related methods and computer-readable media. The computing system includes a secure boot processing system that performs boot-up operations. The secure boot processing system includes an immutable secure boot subsystem that performs lower-level, immutable boot-up tasks that are critical to the security of the computing system. To prevent or mitigate external unauthorized access to the immutable secure boot subsystem that could compromise the security of the computing system, the immutable secure boot controller is configured to disallow external, inbound access to boot system interface of the secure boot processing system to perform immutable boot-up tasks. In this manner, there is not an access path for an external agent to change early immutable boot-up tasks performed by the immutable secure boot subsystem that could otherwise corrupt the computing system.

### FIELD OF THE DISCLOSURE

The technology of the disclosure relates to computing systems employing one or more central processing units (CPUs), and more particularly boot-up operations in the CPUs.

### BACKGROUND

Computing systems include one or more central processing units (CPUs). The CPUs are provided as integrated circuit (IC) chips (also called “CPU chips”) that are mounted on a circuit board. The computing system can also include other computing resources mounted on the same or a coupled circuit board, such as boot storage, memory, and interfacing circuits. For example, if the computing system is employed as a computer server, the computing system can be provided on a circuit board as server blade.

The computing system undergoes a start-up process known as a “boot” or “boot-up” process when a power cycle occurs or a reset is performed. During a boot process, various hardware components and software processes in the computing system are initialized and other boot-up operations performed to prepare these components and processes to be able to perform tasks according to operating system and application software executed by a CPU. A computing system may include a separate boot processor that loads in and executes a boot program code to perform lower-level boot-up operations to prepare the hardware and software components in the computing system to be utilized. It is usually desired for the boot program code to be able to change and be upgraded or updated over time, so the boot program code is typically loaded from a boot memory, such as a programmable read-only memory (ROM), that is separate and apart from the boot processor. When the boot processor undergoes a reset, the boot processor has a lower-level bootloader program code that can be executed to load in a boot program code from the boot memory. In this manner, the boot program code can be updated over time. The boot processor executes the boot program code to perform boot-up operations, including but not limited to initialization of clock circuits, power controls system, interfaces, memory systems, and loading in basic input/output system (BIOS) firmware to be executed by the CPU to perform CPU-specific boot-up operations.

It is important that the computing system is designed to include a secure boot-up system to avoid unauthorized software and physical attacks into the resources of the CPU. One example of such an attack is to obtain access to internal memory of the computing system, which may provide information on the operation of the CPU. It is also important to prevent physical attacks during a boot-up operation process of a computing system. Thus, as part of a secure boot-up design for a computing system, it is important that the computing system have the capability to determine if the boot-up operation processes are behaving in an expected manner and to detect any behaviors that are unexpected. For example, loading in an unauthorized modified version of boot program code from boot memory would be an unexpected behavior. If a third party can modify the boot program code such that the boot process of the computing system executes the modified boot program code without detecting the modification, the third party can alter and control the boot-up operations of the computing system. These altered boot-up operations can include other tampering into the operations of the computing system that can make the CPU vulnerable to other attacks.

The Trusted Platform Modules (TPM) standard ISO/IEC 11889 has been developed to secure hardware in computing systems through integrated cryptographic keys. The TPM standard calls for providing a separate processor in a computing system for creating a hash key summary of a hardware and software configuration of a computing system as part of a boot-up operation to verify that the software has not been changed. The job of the TPM processor is to ensure that the boot process starts from a trusted combination of hardware and software and continues until the operating system of the CPU has been loaded and fully booted and applications are running. However, the TPM processor has to be booted-up and be operational itself to be able to perform verifications of the hardware and software configuration of a computing system.

### SUMMARY

Aspects disclosed herein include computing systems employing a secure boot processing system that disallows in-bound access when performing immutable boot-up tasks for enhanced security. Related methods and computer-readable media are also disclosed. The computing system includes one or more central processing unit (CPUs) that each include one or more CPU cores. The computing system includes a secure boot processing system that includes one or more processors that perform boot-up operations in response to the computer system being powered on or reset (referred to as “power-on reset” (POR)). The secure boot processing system includes a secure boot processor that includes an immutable secure boot subsystem that includes an immutable secure boot controller. The immutable secure boot controller performs lower-level, immutable boot-up tasks. The immutable secure boot controller can also generate requests over a boot system interface of the secure boot processing system to initiate boot-up operations for other components and peripherals external to the secure boot processing system. These immutable boot-up tasks performed by the immutable secure boot controller can involve access and control of resources of the computing system that are critical to the security of the computing system, and thus are critical to secure the computing system from being corrupted from unauthorized devices or agents outside of the secure boot subsystem.

In this regard, in exemplary aspects disclosed herein, to prevent or mitigate the ability of an unauthorized device or agent access to the immutable secure boot subsystem that could compromise the security of the computing system, the immutable secure boot controller is configured to disallow external, inbound access to boot system interface of the secure boot processing system to perform immutable boot-up tasks. In this manner, there is not an access path for an external unauthorized device or agent to change early immutable boot-up tasks performed by the immutable secure boot controller, or otherwise access the secure boot processing system that could corrupt the computing system. After the immutable boot-up tasks are performed, the immutable secure boot controller can allow external, inbound access to the boot system interface of the secure boot processing system. In this regard, the immutable secure boot controller allows inbound access to the boot system interface to cause a bootloader program to be loaded into a bootloader memory that is accessible to the secure boot processor in the secure boot processing system. The secure boot processor can execute instructions in the loaded-in bootloader program to perform mutable boot-up tasks that are a part of boot-up operations. Thus, the secure boot processing system is designed on the principal of least privileges wherein the secure boot processing system only allows access to resources that are desired or necessary to perform assigned functions.

In one example, the secure boot processing system includes a plurality of boot system interfaces. For example, one boot system interface of the secure boot processing system may be coupled to an input/output (I/O) bus that is coupled to the bootloader memory that is configured to store the loaded-in bootloader program. In one example, inbound access from the I/O bus to the secure boot processing system may be disallowed by the secure boot processing system not having an inbound port coupled to the I/O bus. In this manner, only outbound requests are physically allowed by the secure boot processing system to the I/O bus. Another boot system interface of the secure boot processing system may be coupled to a dedicated bootloader bus that is coupled to an external memory that stores the bootloader program and is accessed under control of the immutable secure boot controller to load in the bootloader program from the external memory to the bootloader memory. Other methods of not allowing access to the secure boot processing system in response to performing immutable boot-up tasks can also be provided.

Note that the secure boot processing system may include hardware resources to perform trusted management module (TMM) tasks to verify the hardware and software configuration of the computing system setup as part of the boot-up operation. For example, the secure boot processing system can support use of cryptographic keys to verify the image bootloader program loaded in from external memory to be executed by the secure boot processor as part of performing mutable boot-up tasks. The bootloader program can be verified by TMM tasks. However, the immutable secure boot controller may perform the lower-level, immutable boot-up tasks of the boot-up operation before TMM resources are available as a security resource. Thus, by the secure boot processing subsystem and its immutable secure boot controller being configured to not allow inbound access to secure boot processing system in response to performing immutable boot-up tasks, external devices or agents cannot access resources in or available to the secure boot processing system that may otherwise be available before TMM resources are available.

In other exemplary aspects, the immutable secure boot controller includes a bootstrap controller that is configured to perform a hardware state machine out of POR. The bootstrap controller can be provided to execute a hardware state machine (e.g., register transfer level (RTL) circuits) to perform the initial immutable boot-up tasks not based solely on execution of firmware. In this regard, in response to a POR of the computing system, the bootstrap controller is configured to execute the hardware state machine to initially disallow inbound access to secure boot processing system through the secure boot system interface for security reasons. The bootstrap controller can perform immutable boot-up tasks, such as initialization clock circuits for example. In one example, the bootstrap controller can also access one or more boot mode registers (e.g., electronic fuses (efuses)) to determine security policies and related authentication indicators (e.g., keys) to determine the boot mode of the computing system to determine the appropriate immutable boot-up tasks to be performed based on the boot mode. The bootstrap controller is configured to perform boot-up tasks to make certain hardware resources in the secure boot processing system available or not available depending on the boot mode for enhanced security, and because in this example, at this point in the boot-up operations, the TMM processor is not available to perform security. In one example, the subsequent immutable boot-up tasks based on the boot mode are performed by the secure boot processor in the immutable secure boot subsystem executing instructions from an immutable boot read-only memory (ROM) program stored in on-chip ROM. Different immutable boot-up tasks can be performed based executing the boot ROM program based on the boot mode. For example, if the boot mode registers indicate a debug boot mode, the secure boot processor can allow a debug mode interface (e.g., JTAG interface) to be available to allow an external device direct access to the CPUs of the computing system. In another example, if the boot mode registers indicate a return merchandise authorization (RMA) mode, the secure boot processor can make an interface available and accessible for test vectors to be injected into the computing system. Other exemplary boot modes that can be configured in the secure boot processing system includes a security key revocation mode that allows security keys to be revoked security keys, a disable debug mode when normal boot-up operations are desired, and an anti-rollback security mode for preventing a rollback of the security keys.

After appropriate authentications are performed, the immutable secure boot controller can then, for example, execute instructions in the boot ROM program to reallow inbound access to the secure boot processing system through the boot system interface. The immutable secure boot controller can then cause the bootloader program to be loaded from external memory (e.g., an electronically erasable programmable ROM (EEPROM)) into a bootloader memory. Instructions in the bootloader program can then be executed by the secure boot processor to perform mutable boot-up tasks as part of the boot-up operation, including but not limited to performing TMM functions. The mutable boot-up tasks can include initializing other hardware resources in the computing system, including the CPUs, and load-in further software, such as an operating system (OS) for example, to prepare the CPUs for application execution in a normal processing mode after boot-up operations are completed.

In this regard, in one exemplary aspect, a computing system is provided. The computing system comprises a secure boot processing system that comprises a boot system interface and a secure boot processor comprising an immutable secure boot controller. The secure boot processor is coupled to the boot system interface. The secure boot processor subsystem is configured to receive a power-on reset (POR) signal in response to a POR signal indicating a boot-up state. In response to the POR signal indicating the boot-up state, the immutable secure boot controller is configured to disallow inbound access to the secure boot processing system from the boot system interface, perform one or more immutable boot-up tasks, reallow inbound access to the secure boot processing system from the boot system interface, and load in a bootloader program over the boot system interface to a bootloader memory. The secure boot processor is configured to execute the bootloader program in the bootloader memory to perform one or more mutable boot-up tasks.

In another exemplary aspect, a method of performing a secure boot process in a computing system is provided. The method comprises receiving a POR signal in a secure boot processing system. In response to receiving the POR signal indicating the boot-up state, the method also comprises disallowing inbound access to the secure boot processing system from a boot system interface, performing one or more immutable boot-up tasks in the secure boot processing system, reallowing inbound access to the secure boot processing system from the boot system interface, loading in a bootloader program over the boot system interface to a bootloader memory, and executing the bootloader program in the bootloader memory to perform one or more mutable boot-up tasks in the secure boot processing system.

In another exemplary aspect, a non-transitory computer-readable medium is provided. The non-transitory computer-readable medium has stored thereon computer executable instructions which, when executed by a processor, cause the processor to receive a POR signal in a secure boot processing system in response to a POR signal indicating a boot-up state. In response to the POR signal indicating the boot-up state, the computer executable instructions which, when executed by a processor, cause the processor to disallow inbound access to the secure boot processing system from a boot system interface, perform one or more immutable boot-up tasks in the secure boot processing system, reallow inbound access to the secure boot processing system from the boot system interface, load in a bootloader program over the boot system interface to a bootloader memory, and execute the bootloader program in the bootloader memory to perform one or more mutable boot-up tasks in the secure boot processing system.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of an exemplary computing system that includes a plurality of CPUs and also includes a secure boot processing system that disallows in-bound access when performing immutable boot-up tasks for enhanced security;

FIG. 2 is a flowchart illustrating an exemplary boot-up operation process performed by the secure boot processing system in FIG. 1 that disallows in-bound access when performing immutable boot-up tasks for enhanced security;

FIG. 3 is a block diagram illustrating additional exemplary detail of the secure boot processing system in the computing system in FIG. 1;

FIG. 4 is a block diagram illustrating an exemplary security certificate chain configured to be performed by the immutable secure boot controller in the secure boot processing system in FIGS. 1 and 3; and

FIG. 5 is a block diagram of an exemplary processor-based system that includes a computing system that includes a secure boot processing system configured to disallow in-bound access when performing immutable boot-up tasks for enhanced security, including but not limited to the secure boot processing systems in FIGS. 1, 3, and 4.

### DETAILED DESCRIPTION

Aspects disclosed herein include computing systems employing a secure boot processing system that disallows in-bound access when performing immutable boot-up tasks for enhanced security. Related methods and computer-readable media are also disclosed. The computing system includes one or more central processing unit (CPUs) that each include one or more CPU cores. The computing system includes a secure boot processing system that includes one or more processors that perform boot-up operations in response to the computer system being powered on or reset (referred to as “power-on reset” (POR)). The secure boot processing system includes a secure boot processor that includes an immutable secure boot subsystem that includes an immutable secure boot controller. The immutable secure boot controller performs lower-level, immutable boot-up tasks. The immutable secure boot controller can also generate requests over a boot system interface of the secure boot processing system to initiate boot-up operations for other components and peripherals external to the secure boot processing system. These immutable boot-up tasks performed by the immutable secure boot controller can involve access and control of resources of the computing system that are critical to the security of the computing system, and thus are critical to secure the computing system from being corrupted from unauthorized devices or agents outside of the secure boot subsystem.

In this regard, in exemplary aspects disclosed herein, to prevent or mitigate the ability of an unauthorized device or agent access to the immutable secure boot subsystem that could compromise the security of the computing system, the immutable secure boot controller is configured to disallow external, inbound access to boot system interface of the secure boot processing system to perform immutable boot-up tasks. In this manner, there is not an access path for an external unauthorized device or agent to change early immutable boot-up tasks performed by the immutable secure boot controller, or otherwise access the secure boot processing system that could corrupt the computing system. After the immutable boot-up tasks are performed, the immutable secure boot controller can allow external, inbound access to the boot system interface of the secure boot processing system. In this regard, the immutable secure boot controller allows inbound access to the boot system interface to cause a bootloader program to be loaded into a bootloader memory that is accessible to the secure boot processor in the secure boot processing system. The secure boot processor can execute instructions in the loaded-in bootloader program to perform mutable boot-up tasks that are a part of boot-up operations. Thus, the secure boot processing system is designed on the principal of least privileges wherein the secure boot processing system only allows access to resources that are desired or necessary to perform assigned functions.

In one example, the secure boot processing system includes a plurality of boot system interfaces. For example, one boot system interface of the secure boot processing system may be coupled to an input/output (I/O) bus that is coupled to the bootloader memory that is configured to store the loaded-in bootloader program. In one example, inbound access from the I/O bus to the secure boot processing system may be disallowed by the secure boot processing system not having an inbound port coupled to the I/O bus. In this manner, only outbound requests are physically allowed by the secure boot processing system to the I/O bus. Another boot system interface of the secure boot processing system may be coupled to a dedicated bootloader bus that is coupled to an external memory that stores the bootloader program and is accessed under control of the immutable secure boot controller to load in the bootloader program from the external memory to the bootloader memory. Other methods of not allowing access to the secure boot processing system in response to performing immutable boot-up tasks can also be provided.

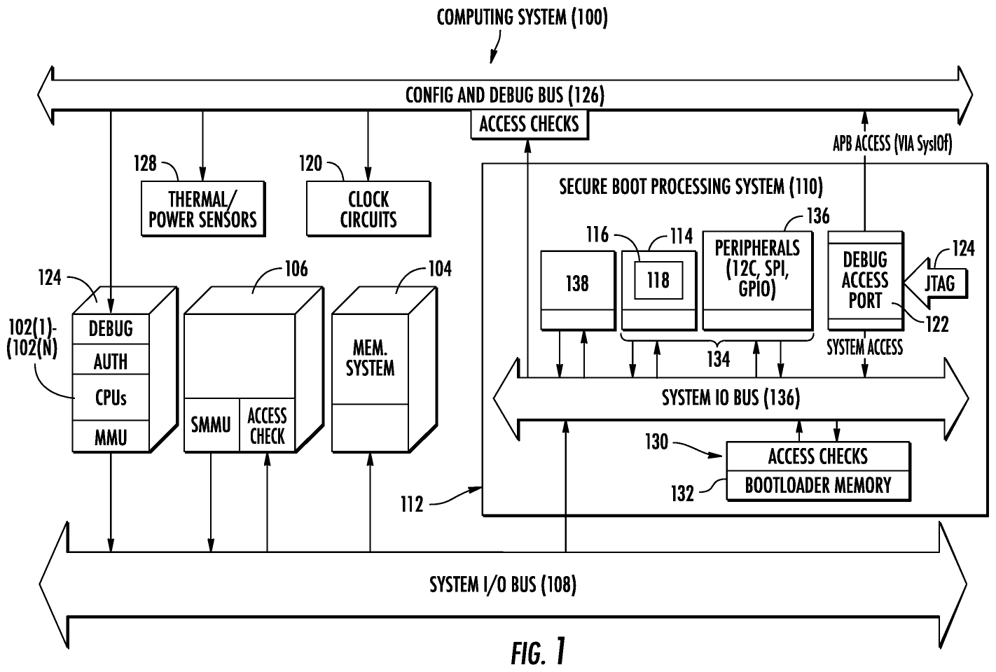

In this regard, FIG. 1 is a block diagram of an exemplary computing system 100 that includes a plurality of CPUs 102(1)-102(N) configured to execute instructions to perform computer-related tasks. The CPUs 102(1)-102(N) may be mounted on a circuit board in multiple sockets such that the computing system 100 is a multi-socket computing system. The CPUs 102(1)-102(N) are configured to access peripheral devices, including a memory system 104 and communications interfaces 106, over a system input/output (I/O) bus 108. The system/O bus 108 can be a mesh network for example. The computing system 100 also includes a secure boot processing system 110 that is configured to perform boot-up operations for the computing system 100 to prepare the CPUs 102(1)-102(N) to be able to execute applications programs in a normal course of operation. The secure boot processing system 110 is configured to initiate boot-up operations in response to a power cycle or reset that generates a power-on reset (POR) signal 112 indicating a boot-up state to the secure boot processing system 110. For example, a board management controller (BMC) (not shown) may be included in the computing system 100, such that the BMC is configured to generate the POR signal 112 in response to detecting a power cycle of a power signal supplying power to the computing system 100.

With continuing reference to FIG. 1, the secure boot processing system 110 in this example includes a secure boot processor 114 that includes an immutable secure boot subsystem 116. The immutable secure boot subsystem 116 includes an immutable secure boot controller 118. The immutable secure boot controller 118 and the secure boot processor 114 may be included on the same die or chip. The immutable secure boot controller 118 is configured to perform immutable boot-up tasks out of POR. Immutable boot-up tasks are tasks that typically are not desired or required to be changed, updated, or upgraded as part of the boot-up operations of the computing system 100. Immutable boot-up tasks are also boot-up tasks that do not require a bootloader (i.e., boot-up program code) to be loaded in from an external memory to be accessible to the secure boot processing system 110, because a bootloader is employed when flexibility is needed to have the ability to change its program code, in order to change or upgrade mutable boot-up tasks performed in the computing system 100. For example, the immutable secure boot controller 118 may be able to perform immutable boot-up tasks based on a hardware state machine that is based on logic circuits that does not require program code. As another example, the immutable secure boot controller 118 may include an internal read-only memory (ROM) that is programmed at manufacturing with low-level firmware program code that can be executed by the immutable secure boot controller 118 to perform immutable boot-up tasks.

An example of an immutable boot-up task is to initiate clock circuits 120 that generate clock signals for synchronous circuits in the computing system 100. Another example of an immutable boot-up task is determining a boot-up mode of the computing system 100 to control boot-up operations and selectively determine which external interfaces in the secure boot processing system 110 to enable. For example, in a debug boot mode, it may be desired to enable a debug access port 122 to allow debug commands 124 to be issued to the computing system 100 for debug purposes. For example, the debug commands 124 can be provided over a configuration and debug bus 126 to access a debug access port 122 of the CPUs 102(1)-102(N), the clock circuits 120, and thermal/power sensor 128. However, in a normal boot mode, an immutable boot-up task may be to not enable or disable the debug access port 122 as a security measure.

With continuing reference to FIG. 1, the secure boot processor 114 in the secure boot processing system 110 is configured to perform mutable boot-up tasks after the immutable secure boot controller 118 performs its immutable boot-up tasks as part of the boot-up operation. As will be discussed in more detail below, the secure boot processor 114 is configured to execute a bootloader program 130 stored in a bootloader memory 132 to execute. For example, the bootloader memory 132 may be on-chip with the secure boot processing system 110. The bootloader program 130 can be accessed by the secure boot processor 114 to be executed through a boot system interface 134 coupled to a private system input/output (I/O) bus 108 in the secure boot processing system 110. The system I/O bus 108 allows the immutable secure boot controller 118 and the secure boot processor 114 to access other components and peripherals in the secure boot processing system 110 when certain immutable and mutable boot-up tasks are performed. In this manner, if it is needed or desired to change mutable boot-up tasks, such as due to upgrades or changes for the computing system 100, the bootloader program 130 can be updated in the bootloader memory 132.

By dividing the boot-up operations performed by the secure boot processing system 110 into the immutable boot-up tasks performed by the immutable secure boot controller 118 and mutable boot-up tasks performed by the secure boot processor 114, the secure boot processing system 110 provides an enhanced security for performing boot-up operations for the computing system 100. As discussed in more detail below, the immutable secure boot controller 118 can be configured to perform immutable boot-up tasks and to disallow in-bound access to the immutable secure boot controller 118 when performing the immutable boot-up tasks. Because the immutable secure boot controller 118 is not using the bootloader program 130 in the bootloader memory 132 that is accessed through the system I/O bus 108, the immutable secure boot controller 118 can limit or not allow inbound communications to be received through the boot system interface 134 from the system I/O bus 108 when performing immutable boot-up operations, as a measure of security. These immutable boot-up tasks performed by the immutable secure boot controller 118 can involve access and control of resources of the computing system 100 that are critical to the security of the computing system 100, and thus are critical to secure the computing system 100 from being corrupted from external unauthorized devices or agents.

In this example, after the immutable boot-up tasks are performed, the immutable secure boot controller 118 can allow external, inbound access to the boot system interface 134. The immutable secure boot controller 118 causes the bootloader program 130 to initially be loaded through a bootloader bus 136 coupled to an external memory (not shown) (e.g., an electronically-erasable programmable read-only memory (EEPROM)) and forwarded over the system I/O bus 108 to the bootloader memory 132 to be stored and later available for the secure boot processor 114 to execute to perform mutable boot-up tasks. The secure boot processor 114 can perform mutable boot-up tasks as part of continued boot-up operations. In this regard, the secure boot processing system 110 in FIG. 1 is designed on the principle of least privilege wherein the secure boot processing system 110 only allows accesses to resources that are absolutely necessary to perform assigned functions.

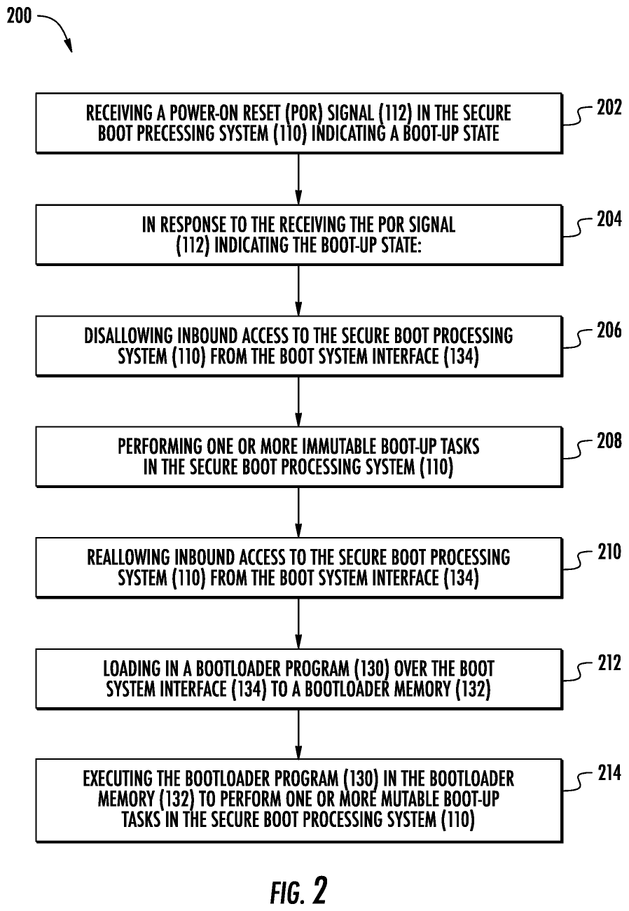

FIG. 2 is a flowchart illustrating an exemplary boot-up operation process 200 performed by the secure boot processing system 110 in the computing system 100 FIG. 1 that disallows in-bound access when performing immutable boot-up tasks for enhanced security. The boot-up operation process 200 in FIG. 2 is discussed in conjunction with the secure boot processing system 110 in FIG. 1.

In this regard, as shown in FIG. 2, a step in the boot-up operation process 200 in the secure boot processing system 110, and more particularly the immutable secure boot controller 118, is receiving the POR signal 112 indicating a boot-up state of the computing system 100 (block 202 in FIG. 2). In response to the receiving the POR signal 112 indicating the boot-up state (block 204 in FIG. 2), a next step in the boot-up operation process 200 is the immutable secure boot controller 118 disallowing inbound access to the secure boot processing system 110 from the boot system interface 134 (block 206 in FIG. 2). A next step in the boot-up operation process 200 is the immutable secure boot controller 118 performing one or more immutable boot-up tasks in the secure boot processing system 110 (block 208 in FIG. 2). Once the immutable secure boot controller 118 finishes performing its immutable boot-up tasks or designated immutable boot-up tasks that are performed when the secure boot processing system 110 is deemed to be in a higher vulnerability state from external attacks, a next step in the boot-up operation process 200 is the immutable secure boot controller 118 reallowing inbound access to the secure boot processing system 110 from the boot system interface 134 (block 210 in FIG. 2). A next step in the boot-up operation process 200 is the immutable secure boot controller 118 loading in a bootloader program 130 over the boot system interface 134 to a bootloader memory 132 (block 212 in FIG. 2). This makes the bootloader program 130 accessible to the secure boot processing system 110 to allow a next step in the boot-up operation process 200 of the secure boot processor 114, executing the bootloader program 130 in the bootloader memory 132 to perform one or more mutable boot-up tasks in the secure boot processing system 110 (block 214 in FIG. 2).

With reference back to FIG. 1, note that the secure boot processing system 110 may include other boot systems, including a power management boot processor 138. The power management boot processor 138 in this example also performs boot-up operations involved in initializing power management systems for the computing system 100.

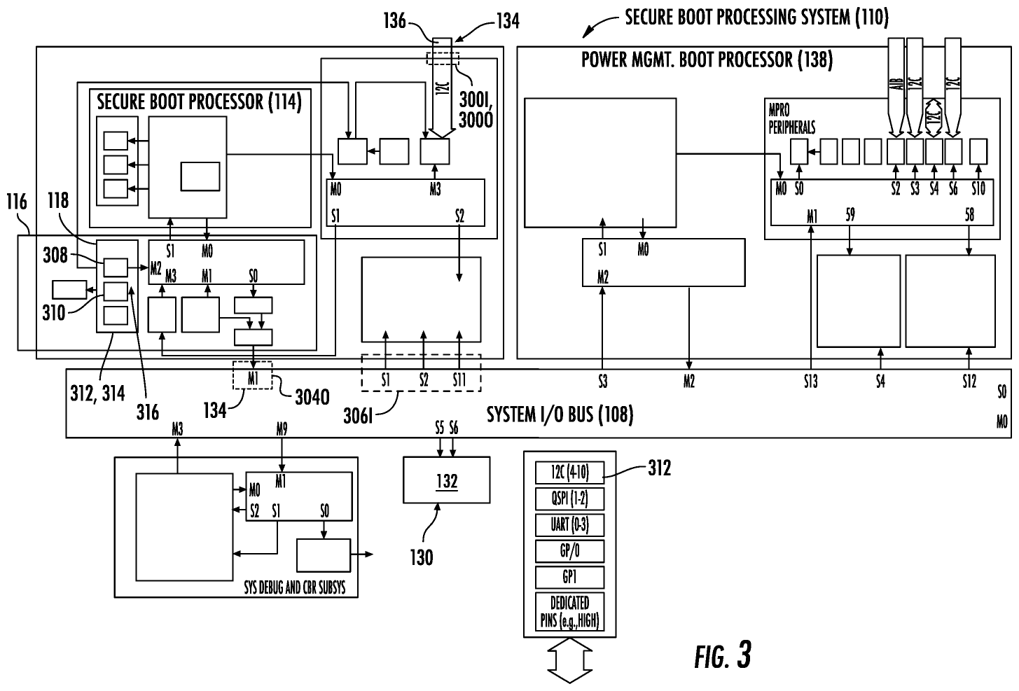

FIG. 3 is a block diagram illustrating additional exemplary detail of the secure boot processing system 110 in the computing system 100 in FIG. 1. As shown therein, the boot system interface 134 includes two interfaces. A first interface provided in the boot system interface 134 is a bootloader input port(s) 300I and bootloader output port 300O that are coupled to a bootloader bus 136 (as part of the boot system interface 134) (e.g., an I²C bus) that is coupled to external memory (not shown). The bootloader input port(s) 300I is configured to receive inbound communications from the bootloader bus 136 to pass to the secure boot processor 114. The bootloader output port(s) 300O is configured to receive outbound communications from the secure boot processor 114 to provide over the bootloader bus 136. The bootloader bus 136 supports the loading in of the bootloader program 130 over the bootloader input port(s) 300I to be stored by the secure boot processor 114 in the bootloader memory 132. In this manner, the bootloader program 130 can be executed by the secure boot processor 114 to perform mutable boot-up tasks as discussed above with regard to FIGS. 1 and 2. The boot system interface 134 in this example also includes a system output port 304O coupled to the system I/O bus 108. This provides access to the secure boot processor 114 and its immutable secure boot controller 118 to provide outbound communications on the system I/O bus 108 destined for other peripherals and devices in the secure boot processing system 110 to perform boot-up tasks. Note that in this example, an input port is not provided between the system I/O bus 108 and the immutable secure boot subsystem 116.

In this example, when the immutable secure boot controller 118 desires to disallow inbound access to the secure boot processing system 110 from the boot system interface 134, the immutable secure boot controller 118 disallows inbound access by the bootloader bus 136 through the bootloader input port(s) 300I. For example, the immutable secure boot controller 118 may disable or deactivate the bootloader input port(s) 300I. In this manner, the bootloader bus 136 cannot be used by an external device to try to gain access to the secure boot processing system 110 when not desired by the immutable secure boot controller 118, such as during the performance of immutable boot-up tasks. Also in this example, when the immutable secure boot controller 118 desires to disallow inbound access to the secure boot processing system 110 from the boot system interface 134, the immutable secure boot controller 118 disallows inbound access through the system I/O bus 108. However, in this example, this is accomplished by an input port not being physically provided between the immutable secure boot subsystem 116 and the system I/O bus 108. In this manner, as examples the immutable secure boot controller 118 can disallow inbound communications over the system I/O bus 108 to access systems in the secure boot processing system 110, such as a cryptographic circuit 312 used for cryptographic authentication and boot mode registers 314 used to determine the boot mode of the computing system 100 (discussed in more detail below). The system output port 304O can be used by the immutable secure boot controller 118 to stream the bootloader program 130 received from the bootloader bus 136 over the system I/O bus 108 to be stored in the bootloader memory 132. The secure boot processor 114 can access the bootloader program 130 in bootloader memory 132 through the system I/O bus 108 through system input port(s) 306I that are controlled to not allow access to the immutable secure boot subsystem 116 and the immutable secure boot controller 118.

With continuing reference to FIG. 3, in one example, the immutable secure boot controller 118 is a bootstrap controller 308 that is configured to execute a hardware state machine to perform at least one immutable boot-up task among the one or more immutable boot-up tasks. For example, the hardware state machine may be realized by logic circuits that do not execute software or firmware instructions. It may be desired for the bootstrap controller 308 to be able to perform certain immutable boot-up tasks by executing program code in a read-only-memory (ROM). In this regard, the bootstrap controller 308 in this example includes an immutable boot ROM 310 configured to store a boot ROM program 316 that can be executed to perform immutable boot-up tasks in the computing system 100. For example, the bootstrap controller 308 may be configured to authenticate the downloaded bootloader program 130 over the bootloader bus 136 when the bootstrap controller 308 determines as part of its boot-up logic to load in the bootloader program 130 over the bootloader bus 136, based on instructions executed from the boot ROM program 316. In this instance, the bootstrap controller 308 will allow inbound access to the bootloader input port(s) 300I to receive the bootloader program 130. The bootstrap controller 308 may authenticate the bootloader program 130 based on performing a cryptographic function according to executed instructions in the boot ROM program 316. In this manner, the risk of allowing inbound access by the bootloader bus 136 through the bootloader input port(s) 300I is mitigated based on this authentication process. In this example, when the bootstrap controller 308 is at a phase of its boot-up operation that the boot ROM program 316 is being executed, functions necessary to authenticate the bootloader program 130 are available. If the bootloader program 130 is authenticated, the secure boot processing system 110 continues with its boot-up operations. If the bootloader program 130 is not authenticated, the secure boot processing system 110 can discontinue boot-up operations.

For example, the secure boot processing system 110, and its immutable secure boot subsystem 116 in particular, may include one or more boot mode registers 314 that are configured to store a boot mode of the computing system 100. The boot mode controls the boot operations and flow performed by the immutable secure boot controller 118. For example, different security measures and allowance/disallowance of access of inbound communications to the immutable secure boot subsystem 116 and secure boot processing system 110 are dependent on the particular boot mode of the computing system 100. In this regard, when the immutable secure boot controller 118 is initiated to perform immutable boot-up tasks in response to the POR signal 112, the immutable secure boot controller 118 accesses the boot mode register(s) 314. As an example, the boot mode register(s) 314 can be provided in the form of electronic fuse (efuse) circuits that can be read and then purposefully blown as part of boot-up operations to not allow changes. The immutable secure boot controller 118 determines the boot mode of the computing system 100 based on the accessed boot mode register(s) 314. The immutable secure boot controller 118 then performs the immutable boot-up tasks based on the determined boot mode for the computing system 100.

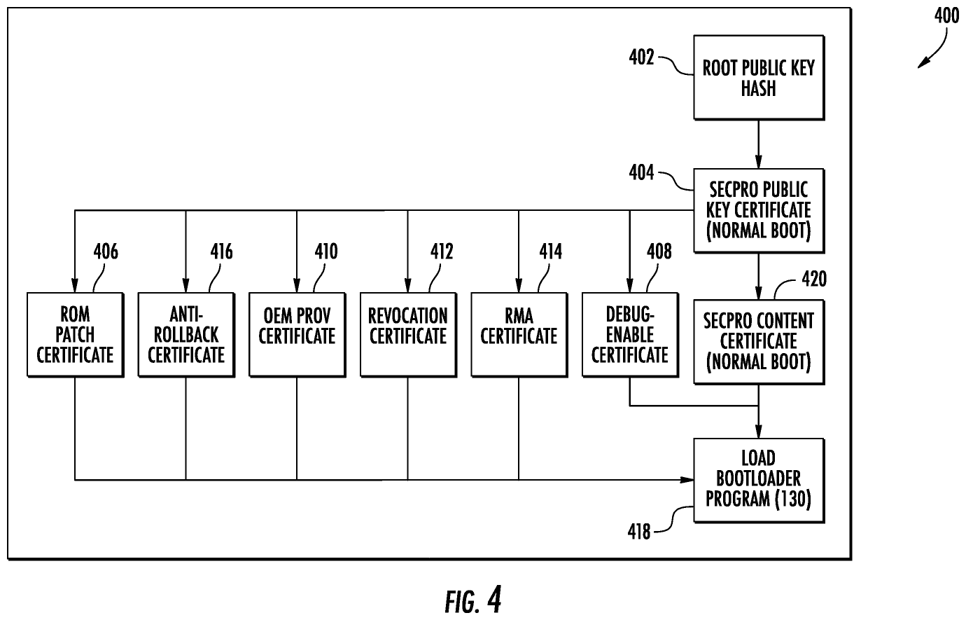

In this regard, FIG. 4 is a block diagram illustrating an exemplary security certificate chain process 400 performed by the immutable secure boot controller 118 as part of executing the boot ROM program 316 based on the determined boot mode of the computing system 100. As shown in FIG. 4, a first step of the security certificate chain process 400 performed by the immutable secure boot controller 118 is to access a root, production public key hash to initiate a cryptographic circuit 312 used for cryptographic authentication (block 402 in FIG. 4). For example, the production public key hash may be stored in the immutable boot ROM 310. Next, the immutable secure boot controller 118 can load the secure boot processor 114 with associated public key certificates that can be used to authenticate the secure boot processor 114 (block 404 in FIG. 4). If authenticating the secure boot processor 114 passes, the immutable secure boot controller 118 can determine the boot mode of the computing system 100 by accessing the boot mode register(s) 314 and then performing the appropriate immutable boot-up tasks based on the boot mode. If the immutable secure boot controller 118 determines that the boot mode is a normal boot mode, the immutable secure boot controller 118 can perform the immutable boot-up tasks not based on any particular special processing, including allowing inbound access through the boot system interface 134 as needed. In this example, other boot modes of ROM patch, anti-rollback, original equipment manufacturer (OEM) provisioning, revocation, return merchandise authorization (RMA) and debug-enable are optionally supported.

With continuing reference to FIG. 4, if the immutable secure boot controller 118 determines that the boot mode is ROM patch, the immutable secure boot controller 118 can perform immutable boot-up tasks that include updating or patching the boot ROM program 316 in the immutable boot ROM 310 (block 406 in FIG. 4). The immutable secure boot controller 118 can call on the cryptographic circuit 312 to verify the certificate in the patch for the boot ROM program 316 to ensure that the patch is verified and authenticated to be allowed. If the immutable secure boot controller 118 determines that the boot mode is debug enabled, the immutable secure boot controller 118 can perform immutable boot-up tasks that allow debugging access to the computing system 100 (block 408 in FIG. 4). For example, the immutable secure boot controller 118 could allow inbound access to the computing system 100 through the configuration and debug bus 126 (FIG. 1) as a boot system interface 134. The immutable secure boot controller 118 can call on the cryptographic circuit 312 to verify the certificate for the debug enable boot mode to ensure that debugging is allowed before performing immutable boot-up tasks that allow debug access to the computing system 100.

With continuing reference to FIG. 4, if the immutable secure boot controller 118 determines that the boot mode is OEM provisioning boot mode, the immutable secure boot controller 118 can perform immutable boot-up tasks that allow OEM provisioning of the bootloader program 130 to be executed by the secure boot processor 114 (block 410 in FIG. 4). The immutable secure boot controller 118 can call on the cryptographic circuit 312 to verifying the certificate for the OEM provisioning of the bootloader program 130 to ensure that the bootloader program 130 is allowed before performing immutable boot-up tasks that allow the bootloader program 130 to be stored in the bootloader memory 132 to be used by the secure boot processor 114. If the immutable secure boot controller 118 determines that the boot mode is revocation boot mode, the immutable secure boot controller 118 can perform immutable boot-up tasks that allow the root public key hash to be revoked that is used as to authenticate certificates (block 412 in FIG. 4). The immutable secure boot controller 118 can call on the cryptographic circuit 312 to verifying the certificate for the revocation of the root public key hash to ensure that the root public key hash is to be revoked before allowing this boot mode. If the immutable secure boot controller 118 determines that the boot mode is RMA boot mode, the immutable secure boot controller 118 can perform immutable boot-up tasks that allow the manufacturer or other authorized party of the manufacturer to gain access to the computing system 100 and secure the boot processing system 110 through a boot system interface 134 (block 414 in FIG. 4). The immutable secure boot controller 118 can call on the cryptographic circuit 312 to verify the certificate for the RMA before allowing this boot mode. If the immutable secure boot controller 118 determines that the boot mode is anti-rollback boot mode, the immutable secure boot controller 118 can perform immutable boot-up tasks that prevent the rollback of the boot ROM program 316 in the immutable boot ROM 310 (block 416 in FIG. 4). The immutable secure boot controller 118 can call on the cryptographic circuit 312 to verifying the certificate for anti-rollback before allowing this boot mode. Also, as an example, if the immutable secure boot controller 118 determines that the boot mode is anti-rollback boot mode, the immutable secure boot controller 118 can cause an existing bootloader program 130 previously stored in the bootloader memory 132 to be executed by the secure boot processor 114 to perform mutable boot-up tasks. The existing bootloader program 130 previously stored in the bootloader memory 132 is known to be a valid, authorized copy based on its previous authentication by the immutable secure boot controller 118.

After the boot mode is determined and the immutable boot-up tasks performed by the immutable secure boot controller 118 are completed based on the determined and authenticated boot mode, the immutable secure boot controller 118 can allow inbound access to the bootloader input port(s) 300I for the bootloader program 130 to be loaded from the bootloader bus 136 into the bootloader memory 132 to be executed by the secure boot processor 114. The secure boot processor 114 can then continue with performing mutable boot-up tasks, including loading in the bootloader program 130 over the bootloader interface 136 to the bootloader memory 132 (block 418 in FIG. 4). The secure boot processor 114 can then execute of the bootloader program 130 as part of the boot-up operations of the computing system 100.

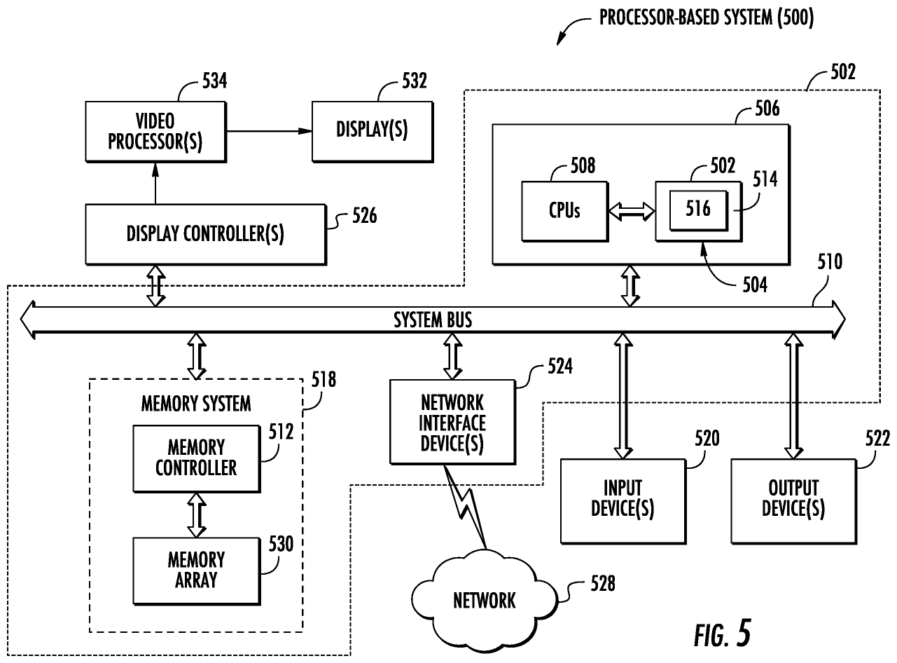

FIG. 5 is a block diagram illustrating an example of a processor-based system 500 that can include a secure boot processing system 502, which can include the secure boot processing system 110 in FIGS. 1 and 3, as non-limiting examples. The secure boot processing system 502 includes an immutable secure boot controller 516 configured to perform immutable boot-up tasks and disallow in-bound access when performing the immutable boot-up tasks, and a secure processor configured to perform mutable boot-up tasks. The secure boot processing system 502 is configured to perform a boot-up operation process in response to a received POR signal 504, which can initiate the immutable secure boot controller 516 (e.g., like the immutable secure boot controller 118 in FIGS. 1 and 3) in the secure boot processing system 502 to perform immutable boot-up tasks. The immutable secure boot controller 516 is part of the secure boot processor 514 (e.g., like the secure boot processor 114 in FIGS. 1 and 3). Mutable boot-up tasks can be performed by the secure boot processor 514 in the secure boot processing system 502. In this example, the processor-based system 500 includes a processor 506 that includes one or more CPUs 508. The CPU(s) 508 is coupled to a system bus 510 and can intercouple initiator and target devices included in the processor-based system 500. As is well known, the CPU(s) 508 communicates with these other devices by exchanging address, control, and data information over the system bus 510. For example, the CPU(s) 508 can communicate bus transaction requests to a memory controller 512 as an example of a slave device as part of a memory system 518. Although not illustrated in FIG. 5, multiple system buses 510 could be provided, wherein each system bus 510 constitutes a different fabric.

Other initiator and target devices can be connected to the system bus 510. As illustrated in FIG. 5, these devices can include the memory system 518, one or more input devices 520, one or more output devices 522, one or more network interface devices 524, and one or more display controllers 526, as examples. The input device(s) 520 can include any type of input device, including, but not limited to, input keys, switches, voice processors, etc. The output device(s) 522 can include any type of output device, including, but not limited to, audio, video, other visual indicators, etc. The network interface device(s) 524 can be any device(s) configured to allow exchange of data to and from a network 528. The network 528 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 524 can be configured to support any type of communications protocol desired. The memory system 518 can include the memory controller 512 coupled to one or more memory arrays 530 to store data.

The CPU(s) 508 may also be configured to access the display controller(s) 526 over the system bus 510 to control information sent to one or more displays 532. The display controller(s) 526 sends information to display(s) 532 to be displayed via one or more video processors 534, which process the information to be displayed into a format suitable for the display(s) 526. The display(s) 526 can include any type of display, including, but not limited to, a cathode ray tube (CRT), a liquid crystal display (LCD), a plasma display, a light emitting diode (LED) display, etc.

The processor-based system 500 in FIG. 5 may include a set of instructions 536 that can be executed by the secure boot processing system and/or the processor 514 to perform tasks. The instructions 536 may be stored in the memory array 530 or the secure boot processing system 502 as examples of non-transitory computer-readable medium 538. The instructions 536 may also reside, completely or at least partially, within the memory system 518 and/or within the secure boot processing system 502 during their execution. The instructions 536 may further be transmitted or received over the network 528 via the network interface device 524, such that the network 528 includes the non-transitory computer-readable medium 538.

While the non-transitory computer-readable medium 538 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The initiator devices and target devices described herein may be employed in any circuit, hardware component, integrated circuit (IC), or IC chip, as examples. A processor is a circuit that can include a microcontroller, a microprocessor, or other circuit that can execute software or firmware instructions. A controller is a circuit that can include microcontroller, a microprocessor, and/or dedicated hardware circuits (e.g., a field programmable gate array (FPGA)) that do not necessarily execute software or firmware instruction. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of non-transitory computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A computing system, comprising:
a secure boot processing system, comprising:
a boot system interface; and
a secure boot processor comprising an immutable secure boot controller, the secure boot processor coupled to the boot system interface;
the secure boot processing system configured to:
receive a power-on reset (POR) signal indicating a boot-up state; and
in response to the reset signal indicating the boot-up state:
the immutable secure boot controller is configured to:
disallow an inbound access to the secure boot processing system from the boot system interface;
perform one or more immutable boot-up tasks;
reallow inbound access to the secure boot processing system from the boot system interface; and
load in a bootloader program over the boot system interface to a bootloader memory; and
the secure boot processor is configured to execute the bootloader program in the bootloader memory to perform one or more mutable boot-up tasks.

2. The computing system of claim 1, further comprising the bootloader memory,
the bootloader memory coupled to the boot system interface.

3. The computing system of claim 1, wherein:
the boot system interface comprises:
at least one inbound port; and
at least one outbound port; and
the immutable secure boot controller is configured to:
disallow the inbound access to the secure boot processing system by being configured to disable the at least one inbound port of the boot system interface;
reallow the inbound access to the secure boot processing system by being configured to enable the at least one inbound port of the boot system interface; and
load in the bootloader program over the at least one inbound port of the boot system interface to the bootloader memory.

4. The computing system of claim 1, wherein:
the boot system interface comprises:
at least one bootloader input port coupled to a bootloader bus coupled to an external memory; and
at least one input/output (I/O) port coupled to an I/O bus coupled to the bootloader memory;
the boot system interface does not comprise:
an I/O output port coupled to the I/O bus; and
the immutable secure boot controller is configured to:
load in the bootloader program over the bootloader bus on the at least one bootloader input port to the bootloader memory;
disallow the inbound access to the secure boot processing system over the at least one bootloader input port; and
reallow the inbound access to the secure boot processing system from the at least one bootloader input port.

5. The computing system of claim 1, wherein the immutable secure boot controller comprises a bootstrap controller configured to execute a hardware state machine to perform at least one immutable boot-up task among the one or more immutable boot-up tasks.

6. The computing system of claim 1, further comprising:
an immutable boot read-only memory (ROM) storing a boot ROM program;
wherein:
the immutable secure boot controller is configured to execute instructions in the boot ROM program to perform at least one immutable boot-up task among the one or more immutable boot-up tasks.

7. The computing system of claim 1, wherein in response to the reset signal indicating the boot-up state, the immutable secure boot controller is further configured to:
authenticate the bootloader program loaded into the bootloader memory; and
in response to the bootloader program not being authenticated, discontinue boot-up operations in the secure boot processing system.

8. The computing system of claim 1, further comprising a clock circuit;
wherein in response to the reset signal indicating the boot-up state, the immutable secure boot controller is configured initialize the clock circuit as an immutable boot-up tasks among the one or more immutable boot-up tasks.

9. The computing system of claim 1, wherein the secure boot processing system further comprises at least one boot mode register configured to store a boot mode of the computing system.

10. The computing system of claim 9, wherein in response to the reset signal indicating the boot-up state, the immutable secure boot controller is configured to:
access the at least one boot mode register,
determine the boot mode of the computing system based on the accessed at least one boot mode register; and
perform the one or more immutable boot-up tasks based on a determined boot mode.

11. The computing system of claim 10, wherein the at least one boot mode register comprises at least one electronic fuse (efuse) circuit.

12. The computing system of claim 11, wherein the immutable secure boot controller is further configured to blow the at least one efuse circuit after performing the one or more immutable boot-up tasks.

13. The computing system of claim 10, wherein:
the boot system interface comprises a debug interface; and
the immutable secure boot controller is further configured, in response to the reset signal indicating the boot-up state:
access the at least one boot mode register;
determine if a boot mode of the computing system is a debug boot mode based on the accessed at least one boot mode register; and
in response to determining the boot mode is the debug boot mode:
allow inbound access to the secure boot processing system through the debug interface; and
perform the one or more immutable boot-up tasks through the debug interface based on the boot mode being a debug boot mode.

14. The computing system of claim 9, the immutable secure boot controller is further configured to, in response to the reset signal indicating the boot-up state:
access the at least one boot mode register;
determine if a boot mode of the computing system is a return merchandise authorization (RMA) boot mode based on the accessed at least one boot mode register; and
in response to determining the boot mode is the RMA boot mode:
authenticate a RMA certificate stored in a boot ROM program.

15. The computing system of claim 13, the immutable secure boot controller is further configured to, in response to the reset signal indicating the boot-up state:
access the at least one boot mode register;
determine if a boot mode of the computing system is an anti-rollback boot mode based on the accessed at least one boot mode register; and
in response to determining the boot mode is the anti-rollback boot mode:
disallow inbound access to the secure boot processing system through the debug interface.

16. The computing system of claim 15, the immutable secure boot controller is further configured to, in response to determining the boot mode is the anti-rollback boot mode:
cause an existing bootloader program previously stored in the bootloader memory to be executed by the secure boot processor to perform the one or more mutable boot-up tasks.

17. The computing system of claim 11, the immutable secure boot controller further configured to, in response to the reset signal indicating the boot-up state:
access the at least one boot mode register,
determine if a boot mode of the computing system is a OEM provision boot mode based on the accessed at least one boot mode register; and
in response to determining the boot mode is the OEM provision boot mode:
blow the at least one efuse circuit.

18. A method of performing a secure boot process in a computing system, comprising:
receiving a power-on reset (POR) signal in a secure boot processing system; and
in response to the receiving the reset signal indicating a boot-up state:
disallowing inbound access to the secure boot processing system from a boot system interface;
performing one or more immutable boot-up tasks in the secure boot processing system;
reallowing inbound access to the secure boot processing system from the boot system interface;
loading in a bootloader program over the boot system interface to a bootloader memory; and
executing the bootloader program in the bootloader memory to perform one or more mutable boot-up tasks in the secure boot processing system.

19. The method of claim 18, wherein performing the one or more immutable boot-up tasks comprises executing a hardware state machine to perform at least one immutable boot-up task among the one or more immutable boot-up tasks.

20. The method of claim 18, wherein performing the one or more immutable boot-up tasks comprises executing instructions in a boot ROM program to perform at least one immutable boot-up task among the one or more immutable boot-up tasks.

21. The method of claim 18, wherein in response to the POR signal indicating the boot-up state, further comprising:
authenticating the bootloader program loaded into the bootloader memory; and
in response to the bootloader program not being authenticated, discontinuing boot-up operations in the secure boot processing system.

22. The method of claim 18, wherein in response to the POR signal indicating the boot-up state, further comprising:
accessing at least one boot mode register configured to store a boot mode of the computing system;
determining the boot mode of the computing system based on the accessed at least one boot mode register; and
performing the one or more immutable boot-up tasks based on a determined boot mode.

23. The computing system of claim 22, further comprising disabling the at least one boot mode register after performing the one or more immutable boot-up tasks.

24. A non-transitory computer-readable medium having stored thereon computer executable instructions which, when executed by a processor, cause the processor to:
receive a power-on reset (POR) signal in a secure boot processing system in response to a power-on reset (POR) signal indicating a boot-up state; and
in response to the POR signal indicating the boot-up state:
disallow inbound access to the secure boot processing system from a boot system interface;
perform one or more immutable boot-up tasks in the secure boot processing system;
reallow inbound access to the secure boot processing system from the boot system interface;
load in a bootloader program over the boot system interface to a bootloader memory; and
execute the bootloader program in the bootloader memory to perform one or more mutable boot-up tasks in the secure boot processing system.

25. The non-transitory computer-readable medium of claim 24, wherein the computer executable instructions comprise a boot ROM program, wherein when executed by the processor, cause the processor to perform at least one or more immutable boot-up task among the one or more immutable boot-up tasks.

26. The non-transitory computer-readable medium of claim 24, wherein in response to the POR signal indicating the boot-up state, the computer executable instructions which, when executed by the processor, further cause the processor to:
authenticate the bootloader program loaded into the bootloader memory; and
in response to the bootloader program not being authenticated, discontinue boot-up operations in the secure boot processing system.

27. The non-transitory computer-readable medium of claim 24, wherein in response to the POR signal indicating the boot-up state, the computer executable instructions which, when executed by the processor, further cause the processor to:
access at least one boot mode register configured to store a boot mode of the computing system;
determine the boot mode of the computing system based on the accessed at least one boot mode register, and
perform the one or more immutable boot-up tasks based on a determined boot mode.
